(19) United States
(12) Patent Application Publication
(10) Pub. No.: US 2015/0314631 A1
(43) Pub. Date: Nov. 5, 2015

(54) Advertising Insert for a Periodical

(71) Applicant: Glen Edward Matthew, Birchcliff (CA)

(72) Inventor: Glen Edward Matthew, Birchcliff (CA)

(21) Appl. No.: 14/269,162

(22) Filed: May 4, 2014

(51) Int. Cl. B42F 5/00; B42D 13/00

(52) U.S. Cl. CPC B42F 5/00; B42D 13/00

(57) ABSTRACT

A periodical is provided, having an advertising insert placed within its pages. The advertising insert comprises a sheet of flexible media, the sheet of flexible media being divisible into a plurality of removable segments, each of the removable segments being bisected by a plurality of spaced tear lines so as to form removable strips. Each of the removable segments includes at least one advertisement printed thereon.

### FIELD OF THE INVENTION

The present invention relates to the field of advertisements. More specifically, the present invention relates to an advertising insert adapted to be placed within a periodical.

### SUMMARY OF THE INVENTION

According to an embodiment of the invention, there is provided an advertising insert for a periodical, the advertising insert comprising:

a sheet of flexible media, the sheet of flexible media being divisible into a plurality of removable segments, each of the removable segments being bisected by a plurality of spaced tear lines so as to form removable strips, and wherein each of the removable segments includes at least one advertisement printed thereon.

According to another embodiment of the invention, there is provided a periodical, having an advertising insert placed within its pages, the advertising insert comprising:

a sheet of flexible media, the sheet of flexible media being divisible into a plurality of removable segments, each of the removable segments being bisected by a plurality of spaced tear lines so as to form removable strips, and wherein each of the removable segments includes at least one advertisement printed thereon.

### BRIEF DESCRIPTION OF THE DRAWINGS

Embodiments will now be described by way of example only, with reference to the following drawings in which:

FIG. 1 is a perspective view of an embodiment of a tear-away advertising insert adapted for insertion into a periodical, the tear-away advertising insert being folded into recto and verso panels.

FIG. 2 is a perspective view of a removable segment removed from the tear-away advertising insert shown in FIG. 1, the removable segment having been folded into storage panels.

FIG. 3 is a perspective view of a removable segment removed from the tear-away advertising insert shown in FIG. 1, the removable segment having been folded into storage panels and flattened for storage in a pack of cigarette rolling paper holders.

FIG. 4 is a perspective view of a tear-away strip detached from the removable segment shown in FIG. 2, shaped into a roll configuration and ready for insert into a cylindrical structure like a straw or a hand rolled cigarette.

FIG. 5 is a perspective view of a tear-away strip detached from the removable segment shown in FIG. 2, shaped into a folded or accordion-like configuration and ready for insert into a cylindrical structure like a straw or a hand rolled cigarette.

### DETAILED DESCRIPTION OF THE INVENTION

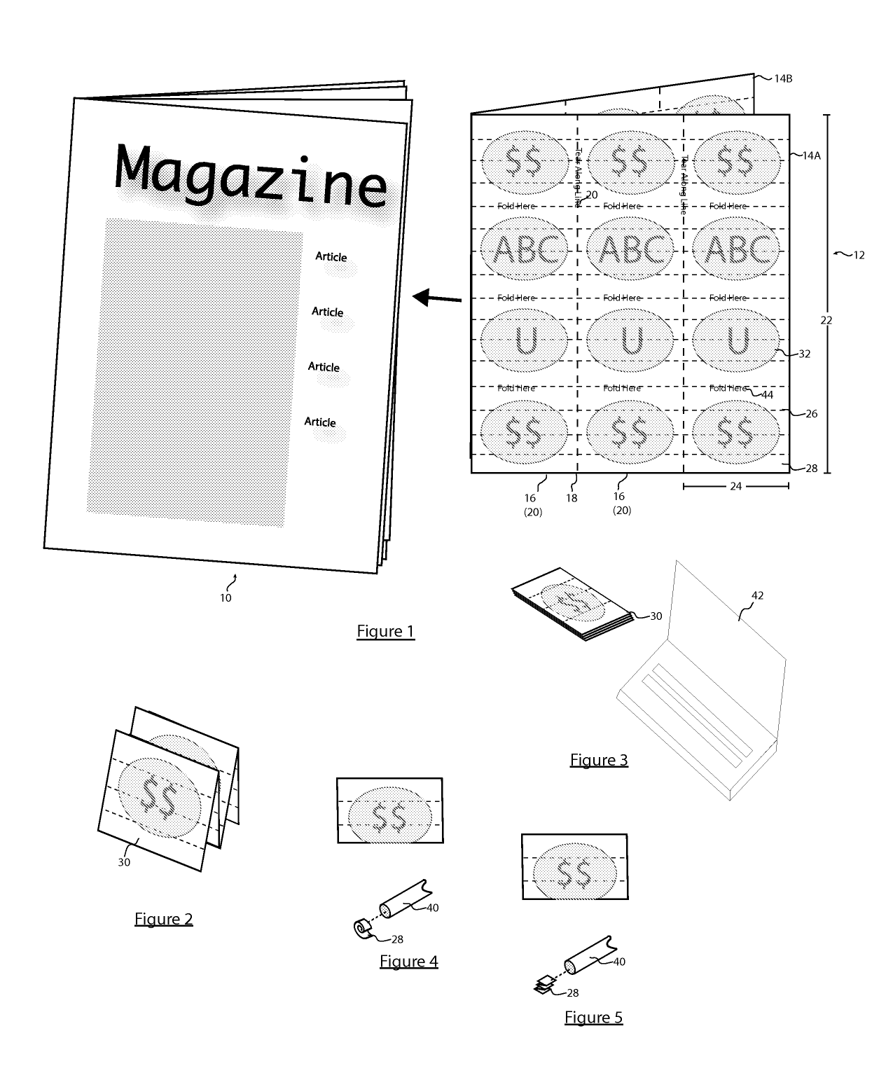

Referring now to FIG. 1, a physical periodical is shown generally at 10. The periodical is typically a magazine of conventional size (approximately 8½″ by 11″/216 mm by 279.4 mm). However, the periodical type and size is not particularly limited. For example, periodical 10 could be a broadsheet newspaper flyer, or a smaller booklet, or other format as may occur to those of skill in the art.

Inserted within the periodical 10 is an advertising insert 12. The approximate size of advertising insert 12 is 11″ by 17″/279.4 mm by 431.8 mm but is not particularly limited in size to those skilled in the art. The advertising insert 12 may be simply placed between the pages of periodical 10, or bound to periodical 10 by saddle-stitch or staple binding or pressure sensitive adhesive glue, or simply associated with the periodical 10 by placing both within a fitted plastic bag or protective wrapping. The advertising insert 12 is comprised of a sheet of flexible material such as cardboard or paper, having a front and back facings. In the presently-illustrated embodiment, the advertising insert is made of a grade of paper or cardstock. While advertising insert 12 is being described as being made of a flexible material, it should preferably be sufficiently stiff so as to retain its current shape when folded. For many implementations (such as a smoking insert system), the flexible material (and optional varnish-like finishing coat) should be non-toxic. The following grades and weights of material have been contemplated:
Book, being uncoated or coated on one or both sides with grams per square meter being 44, 59, 67, 74, 89, 104, 118, 133, 148 and 178;
Bond, being uncoated or coated on one or both sides with grams per square meter being 49, 61, 75, 90, 105, 120, 135 and 158;
Cover, being uncoated or coated on one or both sides with grams per square meter being 135, 163, 176, 216, 243 and 271;
Bristol, being uncoated or coated on one or both sides with grams per square meter being 148, 178, 219, 261, 306 and 351;
Index, being uncoated or coated on one or both sides with grams per square meter being 163, 203, 252 and 328; or
Tag, being uncoated or coated on one or both sides with grams per square meter being 163, 203, 244, 284, 326 and 407.
   The grades and weights of material are not particularly limited, and those of skill in the art may identify other materials, grades and weights.

In the embodiment show in in FIG. 1, the advertising insert is folded in half so as to form opposing recto panel 14A and verso panel 14B. Each of recto panel 14A and verso panel 14B are subdivided into a plurality of removable segments 16 by tear lines 18. Tear lines 18 are typically formed from perforations, creases or scoring, as is known to those of skill in the art. Typically the plurality of removable segments 16 is organized by tear lines 18 into columns 10. In the embodiment shown in FIG. 1, each of opposing recto panel 14A and verso panel 14B are subdivided into three columns 20 of removable segments 16 (three removable segments 16 in total on each panel). The length 22 and width 24 of each removable segment 16 can vary (subject to the maximum dimensions of advertising insert 12). In the embodiment illustrated in FIG. 1, the length 22 of removable segment 16 is 11″ (279.4 mm), and the width 24 is 2.625″ (66.675 mm). In an alternate (not depicted), the length 22 of removable segment 16 is 5.5″ (139.7 mm), and the width 24 is 2.625″ (66.675 mm). Generally speaking, the width 24 of each removable segment 16 is sized to fit various cigarette rolling paper holder types and designs such as Single Width, 1¼ Size, 1½ Size, King Size and Double Width Size.

Each of the removable segments 16 is bisected by a plurality of spaced tear lines 26 so as to form removable strips 28 (FIGS. 4-5). Tear lines 26 are typically formed from perforations, creases or scoring, as is known to those of skill in the art As illustrated, each of removable strips 28 is defined by tear lines 18 and 26. The distance between each row of tear lines 26 can vary to fit the needs of the end user. As illustrated the distance between each row of tear lines 26 will be about ¼ (6.35 mm) apart, thereby allowing the end user to tear-away individual removable strips 28 that are 2.625″ (66.675 mm) long and ¼″ (6.35 mm) wide. Multiple removable strips 28 can be torn off in conjunction to create an effectively larger removable strip.

It is further contemplated that In the present embodiment, tear lines 18 are formed to be more easily torn than spaced tear lines 26 so that each of the removable segments 16 breaks away from an adjacent removable segment 16 more easily than each of the removable strips 18 breaks away from an adjacent removable strips 28. The removable strips 28 can then be used as consumable items such as paper blow darts, syringe plug inserts or cigarette filter tips. Removable strips 28 are sized as to be conveniently rolled (FIG. 4) or folded (FIG. 5), and then inserted into the end of a rolled cigarette 40, or other hollow cylindrical structure such as a straw or syringe (not depicted). Other uses for removable strips 28, such as blow darts, syringe plugs, information strips containing contact information (phone numbers, email, etc.) and shopping lists are also contemplated.

As shown in FIGS. 2 and 3, each removable segment 16 transforms into rectangular storage panels 30 by folding the lower end up using a front face to back face folding order on every 4^{th} tear line 26 (or other number of tear lines 26) forming multiple rectangular storage panels 30 that each have a plurality of removable strips 28. The folded rectangular storage panels 30 allow the removable segment 16 to conveniently collapse for storage in a cigarette rolling paper holder 42 (FIG. 3). Other sizes of cigarette rolling paper holders 42 or other storage containers (e.g., a generic box, package of cigarettes, a pocket, purse or a wallet) will occur to those of skill in the art.

Printed on the surface of each advertising insert 12 is a plurality of advertisements 32. In the embodiment shown in FIG. 1, an advertisement 32 is placed within each storage panel 30. The subject matter of advertisement 32 is not particularly limited, and can include text and/or graphics. In addition, the placement of advertisements 32 is not particularly limited. For example, an advertisement 32 can be straddled across multiple storage panels 30, or placed individually along each removable strip 28. In one embodiment, identical copies of advertisement 32 are symmetrically placed on corresponding storage panels 30 on recto panel 14A and 14B. Thus, as removable strips 28 are removed from the top recto panel 14A or 14B, the image of advertisement 32, which has been partially removed with the torn removable strips 28, remain substantially intact as the missing portions appear in panel 14 below.

Therefore, the drawings and descriptions previously presented are for purposes of illustrating the principles of the present invention. In addition, because many changes and alterations will occur to those skilled in the art so as to meet the needs of the ever changing marketplace, the purpose of the descriptions and drawings is not to limit the invention to exact size, materials, construction, and operation but to note that suitable alterations and equivalents are to be considered as falling within the scope of the invention.

What is claimed is:

1. An advertising insert for a periodical, the advertising insert comprising:
a sheet of flexible media, the sheet of flexible media being divisible into a plurality of removable segments, each of the removable segments being bisected by a plurality of spaced tear lines so as to form removable strips, and wherein
each of the removable segments includes at least one advertisement printed thereon.

2. The adverting insert of claim 1, wherein the sheet is folded into so to form opposing recto and verso panels.

3. The adverting insert of claim 1, wherein each of the removable segments is adapted to be folded along some of the plurality of spaced tear lines so as to form storage panels adapted for being stored within cigarette rolling paper holders of a standard size.

4. The advertising insert of claim 1, wherein each of the removable segments, when folded into storage panels, is sized so as to fit within one of: a package of rolling paper holders, a generic box, a package of cigarettes, a pocket, a purse and a wallet.

5. The adverting insert of claim 1, wherein each of the removable segments is adapted to be folded along some of the plurality of spaced tear lines so as to form storage panels adapted for being stored within cigarette rolling paper holders of a standard size, each of the storage panels including the at least one advertisement.

6. The advertising insert of claim 1, wherein:
the sheet is folded so to form opposing recto and verso panels and that the removable strips formed on the recto panel are symmetrically aligned with the removable strips formed on the verso panel when the opposing recto and verso pages are folded closed; and
an identical at least one advertisement is printed on multiple removable strips on each of the opposing recto and verso panels and symmetrically aligned such that removal of at least one removable strip having a portion of the at least one advertisement from the one of the opposing recto and verso panels reveals an identical portion of the at least one advertisement on the other of the opposing recto and verso panels.

7. The adverting insert of claim 1, wherein the removable strips are adapted to be paper blow darts, cigarette filter tips or syringe plugs.

8. The advertising insert of claim 1, wherein the flexible media is one of card stock and paper.

9. The advertising insert of claim 1, wherein the flexible media has a standard grade of one of: as Book, Bond, Cover, Bristol, Index or Tag.

10. The advertising insert of claim 1, wherein the flexible media has been treated with a varnish-like finishing coat.

11. A periodical, having an advertising insert placed within its pages, the advertising insert comprising:
a sheet of flexible media, the sheet of flexible media being divisible into a plurality of removable segments, each of the removable segments being bisected by a plurality of spaced tear lines so as to form removable strips, and wherein
each of the removable segments includes at least one advertisement printed thereon.

12. The periodical of claim 11, wherein the sheet is folded into so to form opposing recto and verso panels.

13. The periodical of claim 11, wherein each of the removable segments is adapted to be folded along some of the plurality of spaced tear lines so as to form storage panels adapted for being stored within cigarette rolling paper holders of a standard size.

14. The periodical of claim 11, wherein each of the removable segments, when folded into storage panels, is sized so as to fit within one of: a package of rolling paper holders, a generic box, a package of cigarettes, a pocket, purse and a wallet.

15. The periodical of claim 11, wherein each of the removable segments is adapted to be folded along some of the plurality of spaced tear lines so as to form storage panels adapted for being stored within cigarette rolling paper holders of a standard size, each of the storage panels including the at least one advertisement.

16. The periodical of claim 11, wherein:
the sheet is folded so to form opposing recto and verso panels and that the removable strips formed on the recto panel are symmetrically aligned with the removable strips formed on the verso panel when the opposing recto and verso pages are folded closed; and
an identical at least one advertisement is printed on multiple removable strips on each of the opposing recto and verso panels and symmetrically aligned such that removal of at least one removable strip having a portion of the at least one advertisement from the one of the opposing recto and verso panels reveals an identical portion of the at least one advertisement on the other of the opposing recto and verso panels.

17. The periodical of claim 11, wherein the removable strips are adapted to be paper blow darts, cigarette filter tips or syringe plugs.

18. The periodical of claim 11, wherein the flexible media is one of card stock and paper.

19. The periodical of claim 11, wherein the flexible media has a standard grade of one of: as Book, Bond, Cover, Bristol, Index or Tag.

20. The periodical of claim 11, wherein the flexible media has been treated with a varnish-like finishing coat.
